(19) United States
(12) Patent Application Publication
(10) Pub. No.: US 2016/0003728 A1
(43) Pub. Date: Jan. 7, 2016

(54) METHOD OF AND APPARATUS FOR ASCERTAINING THE SIZE OF PARTICLES

(71) Applicant: IMPERIAL INNOVATIONS LIMITED, London (GB)

(72) Inventor: Yannis Hardalupas, London (GB)

(21) Appl. No.: 14/770,237

(22) PCT Filed: Feb. 18, 2014
(86) PCT No.: PCT/GB2014/050463

§ 371 Date: Aug. 25, 2015

(30) Foreign Application Priority Data
Feb. 28, 2013 (GB) 1303620.7

(51) Int. Cl. G01N 15/14

(52) U.S. Cl. CPC G01N 15/1434; G01N 2015/1493; G01N 2015/1454

(57) ABSTRACT

A method of ascertaining the size of small particles is disclosed. The method includes the steps of: a) intersecting at least two light beams at an intersection volume; b) sensing at each of a plurality of sensing positions angularly displaced from one another light scattered by a particle substantially in the intersection volume, and producing respective output signals indicative of the sensed light; c) ascertaining the phase difference between one of the signals and each other of the signals to give a measured indication of the variation of phase difference with angular displacement; and d) comparing the measured indication with at least one known indication of the variation of phase difference with angle for a known particle size and thereby determining the size of the particle substantially in the intersection volume.

This invention relates to a method of and apparatus for ascertaining the size of particles. In particular, this invention relates to ascertaining the size of small particles, such as, for example, particles of less than about 20 μm in diameter.

### BACKGROUND

In certain circumstances, it can be desirable to ascertain the size of small particles.

For example, the particle size of active ingredients in pharmaceutical preparations can be of importance and so may require verification by measurement during a process in which such preparations are made.

The measurement of the particulate content of emissions, such as engine exhaust emissions, may also require the measurement of particle size. Although at present it is usual to measure emissions based on the mass of particles therein, measuring particle number-density based on probabilities that are a function of particle size would be an alternative. This alternative would require the measurement of particles of small size.

One way in which small particles can be measured is to use a phase Doppler anemometer. In this arrangement, two lasers of the same wavelength are focused to intersect in a stream of particles to be measured. The lasers intersect to form a volume of intersection known as the “control volume”. As a particle passes through the control volume, the particle scatters the incident laser light to generate a fringe pattern of scattered light. The phase Doppler anemometer also includes two light sensors, spaced-apart and positioned to sense light of the fringe pattern. Each sensor senses scattered light and produces an output signal with the same frequency as the light incident thereon. In accordance with the Doppler effect, the frequency of the light, and hence of each output signal, is indicative of the velocity of the particle. Of more use in the present case, however, is that the phase difference between the light incident on the two sensors, and hence the phase difference between the two output signals from the sensors, is indicative of the diameter of the particle scattering the light. The diameter is considered to be the “size” of the particle; thus, the particle size can be ascertained.

One problem with this arrangement, however, is that, for smaller particles, the phase shift between light sensed at spaced-apart locations also becomes smaller so that it becomes difficult to measure particle size with accuracy. At least one reason for this worsening accuracy is that diffraction of light by smaller particles is much more pronounced than is the case with larger particles. This problem is apparent with particles of 20 μm in diameter and smaller. Consequently, a phase Doppler anemometer as described above cannot usually be used to determine the size of particles of less than 20 μm in diameter accurately, and certainly cannot be used accurately to measure particles of the order of a few microns or sub-microns in diameter.

An object of this invention is to address this problem.

### SUMMARY

According to a first aspect of this invention, there is provided a method of ascertaining the size of small particles, the method including the steps of:
a) intersecting at least two light beams at an intersection volume;
b) sensing at each of a plurality of sensing positions angularly displaced from one another light scattered by a particle substantially in the intersection volume, and producing respective output signals indicative of the sensed light;
c) ascertaining the phase difference between one of the signals and each other of the signals to give a measured indication of the variation of phase difference with angular displacement; and
d) comparing the measured indication with at least one known indication of the variation of phase difference with angle for a known particle size and thereby determining the size of the particle substantially in the intersection volume.

Whereas the phase Doppler approach referred to above usually requires that the particles which are to be measured be spherical and have smooth surfaces, embodiments of the invention can be used to measure non-spherical particles and particles with rough surfaces. Embodiments are also expected to be insensitive to the refractive index of the particles.

The measured indication of the variation of phase difference with angular displacement may include an indication of the angular position of transitions between local maxima and minima of the phase difference. The indication may include information identifying the angular position of such transitions. The indication may include information identifying the angular position or one or more points on each side of the local maxima and minima. The measured indication of the variation of phase difference with angular displacement may include an indication of the angular position of local maxima and minima of the phase difference. The measured indication may include information indicative of a squarewave of phase difference maxima and minima with angular displacement.

Step (d) may include comparing the measured indication with the known indication to ascertain that the measured indication substantially matches the known indication, thereby determining that the particle size is substantially the known particle size. Step (d) may include comparing the measured indication with a plurality of known indications, each for a respective known particle size, to find a known indication that most closely matches the measured indication and hence a known particle size that most closely matches the particle size. Step (d) may include comparing the measured indication with a plurality of known indications, each for a respective known particle size, to find a pair of known indications between which the measured indication lies, and hence a range of known particle sizes between which the particle size lies. Step (d) may be followed by the step of interpolating between the two known particle sizes to generate a particle size estimate.

The comparison or comparisons of step (d) may be made with pre-generated information that is recorded for subsequent access. The comparison of step (d) may be made with information that is generated on demand.

The or each known indication may be a theoretical indication generated by theory. The or each known indication may be an empirical indication generated by experiment. The or each theoretical indication may be generated in accordance with Mie theory.

The particle may be smaller than 20 μm; it may be smaller than 10 μm; it may be smaller that 1 μm. The particle may be no smaller than 0.2 μm. The minimum size depends on the wavelength of the available laser light. It may be that future availability of appropriate lasers with wavelength of light close to 0.1 μm results in the minimum size of the particle that can be measured being close to 0.1 μm.

The particle may be one of a stream of particles passing through the intersection volume. The method may include the step of passing a stream of particles through the intersection volume and respectively repeating steps of the method to ascertain the size of each of a plurality of particles of the stream.

There may be two light beams. The light beams may be laser beams. The beams may be of light of the same wavelength. The beams may intersect with a beam crossing half-angle of less than 10 degrees. The beam crossing half-angle may be 5 degrees.

The sensing positions may all lie in the same plane. The sensing positions may be angularly displaced from one another around the intersection volume.

The number and position of the sensing positions may be such that transitions between maxima and minima of the phase difference can be detected. The number and position of the sensing positions may be such that at least one sensing position is on each side of at least one maximum or minimum, between that maximum or minimum and the adjacent maximum or minimum. For a plurality of maxima and minima, there may be at lease one sensing position between each maximum or minimum and the adjacent maximum or minimum.

At each sensing position there may be a sensor. The sensing may include generating a respective electrical signal indicative of the light sensed at each sensing position. Each electrical signal may be indicative of the frequency of light intensity fluctuations sensed at the respective sensing position. Each signal may be indicative of the intensity of the light sensed at the respective sensing position.

Some or all of the sensing positions may be out of the plane of the intersecting light beams. The sensing position that gives rise to the one signal in step (c) may be substantially in the plane of the intersecting light beams. Each other sensing position may be out of the plane of the intersecting light beams. The sensing positions may lie in the same plane as each other. The plane of the sensing positions may make an angle of between 10 and 90 degrees relative to the plane of the intersecting laser beams. The intersecting axis of the two planes may bisect the angle made by the intersecting light beams. The angle between the various sensing positions and the intersecting axis of the two planes may be between 0 and 180 degrees.

In an embodiment, the method may additionally comprise measuring the velocity of particles. This may be done in the same way as a phase doppler anemometer measures velocity.

According to a second aspect of this invention, there is provided apparatus for ascertaining the size of small particles, the apparatus including light emitting means arranged to emit at least two light beams that intersect at an intersection volume, a plurality of sensors each positioned at a respective sensing position angularly displaced from one another and operable to sense light scattered by a particle substantially in the intersection volume produce a respective output signal indicative thereof, and processing means operable to ascertain the phase difference between one of the signals and each other signal to give a measured indication of the variation of phase difference with angular displacement, and operable to compare the measured indication with at least one known indication of the variation of phase difference with angle for a known particle size and thereby determining the size of the particle substantially in the intersection volume.

The apparatus of the second aspect may be arranged and operable to carry out a method of the first aspect. Features of the first aspect may therefore be features of the second aspect.

The apparatus may include computer processing means programmed and operable to carry out one or more steps of a method of the first aspect.

According to a third aspect of this invention, there is provided computer processing means programmed and operable to carry out at least steps (c) and (d) of a method according to the first aspect.

According to a fourth aspect of this invention, there is provided a computer program having code portions executable by computer processing means to cause those means to carry out one or more steps of a method according to the first aspect.

According to a fifth aspect, there is provided a record carrier having recorded thereon information indicative of the computer program.

The record carrier may be a computer-readable disk such as, for example, a magnetic disk or an optical disk. The record carrier may be solid state memory such as, for example, ROM or RAM. The record carrier may be a signal, such as, for example, an electrical signal, a wireless radio-frequency signal, or a light signal.

### BRIEF DESCRIPTION OF THE DRAWINGS

Specific embodiments of this invention will now be described by way of example only and with reference to the accompanying drawings, in which:

FIG. 1 is a diagrammatic representation of apparatus that embodies this invention; and

FIG. 2 shows a square wave representing a theoretically calculated variation in frequency phase difference with angular displacement for light scattered by a particle.

### SPECIFIC DESCRIPTION OF AN EXEMPLARY EMBODIMENT

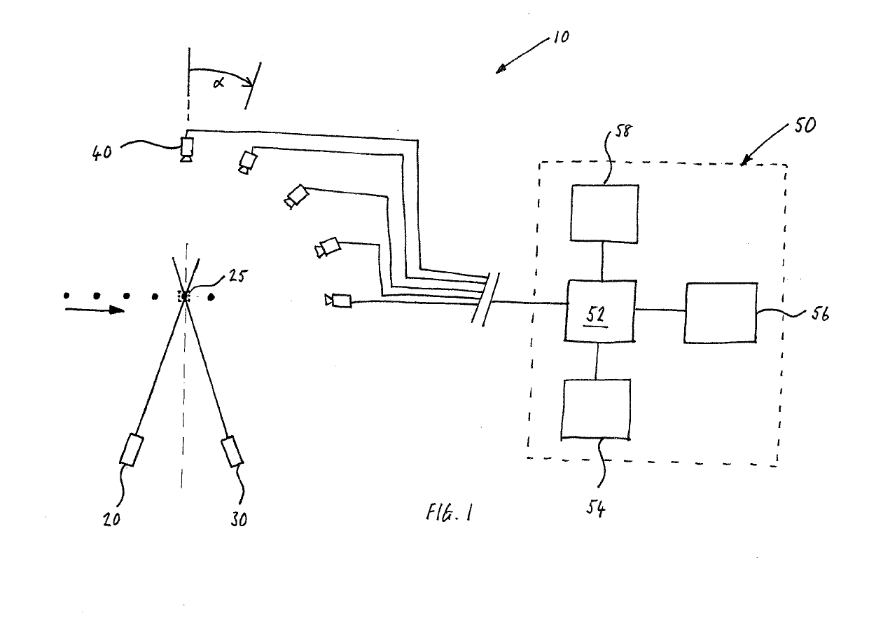

FIG. 1 shows apparatus 10 for use in ascertaining the size of particles. The apparatus 10 includes light emitting means in the form of first 20 and second 30 lasers, each arranged to emit light with the same wavelength. The two lasers 20, 30 are positioned to emit light that intersects to form a volume of intersection referred to as the “control volume” 25. In this embodiment, light emitted by each laser 20, 30 makes an angle of 5 degrees with an axis therebetween on which the control volume 25 lies.

The apparatus 10 further includes several sensors 40, each of which is positioned to sense light emitted from the control volume 25. The sensors 40 are further positioned so as to be angularly displaced from one another about the control volume 25, and to lie in the same plane as each other. Thus, each sensor 40 is angularly displaced by an angle α from one of the sensors 40, referred to herein as the “reference sensor 40”. Although not shown in the drawings for simplicity of illustration, the plane of the sensors 40 is, however, not coplanar with the plane in which the lasers 20, 30 and light emitted thereby lies. Instead, the plane of the sensors 40 is at an angle to the axis. In this embodiment, that angle is 25 degrees. In alternative embodiments, the plane of the sensors may be the same as the plane of the lasers 20,30 and the light emitted thereby.

In the diagrammatic representation of FIG. 1, only four sensors 40 are shown, with these sensors 40 angularly spaced so as to occupy a 90 degree arc. As will be apparent from the following description, however, there would typically be more than four sensors 40 spaced over 180 degrees.

An output from each sensor 40 is connected as an input to processing means in the form of a personal computer 50. The personal computer includes a processor 52, input means 54 in the form or a keyboard and mouse, and output means in the form of a visual display unit 56; all of which is in communication with the processor 52. The computer 50 also includes storage means in the form of a hard disk drive 58 on which a record of information is recorded for access by the processor 52. Where it is necessary for the signals to be digitised before processing and storage by the computer 50, additional hardware, including any additional electronics required to condition the signals, would be provided.

The record of information includes information relating to the particular optical arrangement shown in and described with reference to FIG. 1. In this embodiment, it is envisaged that this information is calculated using known optical theory, such as, for example, by using Mie theory to solve Maxwell's equations. More specifically, the record contains information for each of several different sizes of particle. For each particle, the record includes information indicating the frequency of the scattered light and the phase difference between scattered light at different angular positions in the plane of the sensors 40, where the light is scattered as a result of the particle in question being in the control volume 25. The record also indicates how this phase difference varies with angular displacement in the plane of the sensors 40 from the position of the reference sensor 40. In this embodiment, this information is represented as the angular position in the plane of the sensors 40 of local maxima and minima in the phase difference with respect to the position of the reference sensor 40. Thus the record forms what might be termed a “known” indication of the variation of phase difference with angular displacement for various particle sizes.

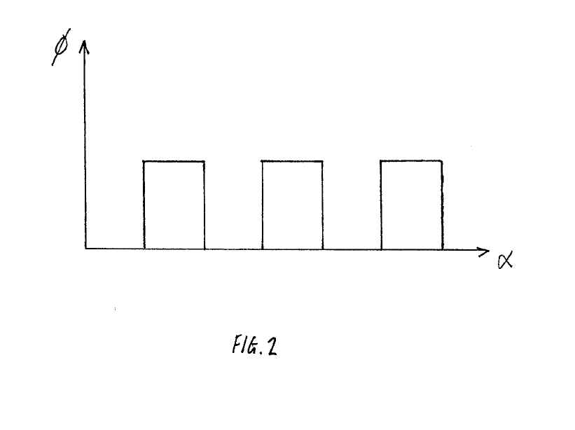

This information may be visualised as shown in FIG. 2, in which a square wave is reproduced indicating the variation of phase difference of scattered light with angular displacement for a particle of a given size.

In this embodiment, such information is stored in the record for particle sizes from 0.2 μm to 20 μm, for every 0.1 μm increase in particle size.

In operation, one particle 60 of a stream of particles enters the control volume 25. Light beams from the two lasers 20, 30 intersect in the control volume 25 and are scattered by the particle 60 to create a diffraction pattern of light around the particle 60. Light of this diffraction pattern is incident on the sensors 40 and is sensed thereby. In response to sensing the incident light, each sensor 40 outputs a respective output signal indicative of the frequency of the light incident thereon. The output signals are received at the personal computer 50. The processor 52 of the personal computer 50 then operates on the output signals to calculate the phase shift between the output signal from the reference sensor 40 and that from each other sensor. As the relative angular positions of the sensors 40 relative to the remainder of the apparatus 10 are known, the computer 50 is further operable to associate with each calculated phase shift, the angular separation between the reference sensor 40 and the respective other sensor 40 that generate the phase-shifted signals. Thus, the computer 50 is operable to generate a measured indication of the variation of phase shift with angular separation.

The processor 52 of the computer 50 then accesses the record 58 in which the known indications of the variation of phase shift with angular separation for each of many different particle sizes is recorded. The processor 52 compares the measured indication with the known indications until the closest matching known indication is found. The processor then accesses the known particle size that corresponds to the closest matching known indication and returns this known particle size to a user by displaying it on the visual display unit 56. As the record includes theoretically calculated information for particle sizes between 0.2 μm and 20 μm, in 0.1 μm increments, where the particle 60 is of a size within this range, the computer 50 returns a particle size within 0.1 μm of the size of the particle 60. Thus the size of the particle 60 is ascertained.

In selecting the number and position of the sensors 40 of the apparatus, it will be appreciated from the foregoing description that, in this embodiment, the arrangement of the sensors 40 is preferably such that the angular positions of local maxima and minima in the phase difference between scattered light sensed at the reference sensor 40 and each other sensor 40 can be identified. The number of minima and maxima depends on particle size and the range of angular positions that are monitored by the sensors. For example, the number of maxima and minima that need to be sensed may vary between 2 for size 0.4 μm and 9 for 1.3 μm, for sensors placed over a range of angles between 0 and 110 degrees.

However, in other embodiments, the sensors 40 may be at other, conceivably variable, angular distances from each other. The number of sensors 40 may also differ and be variable, depending on the size range of the particles. For example, for a particle size of 0.7 μm, it is envisaged that six sensors 40 be placed on one plane at angular distances from each other. The plane of the sensors 40 may be normal to the plane of the intersecting light beams at the bisector location of the two beams. The sensors 40 will be spaced apart with an angular separation from the axis (i.e. an a angle) of between 0 and 120 degrees.

Although in the embodiment described above with reference to the drawings, the phase difference measured at each sensor is with reference to the same reference sensor, it is envisaged that the phase difference may alternatively be measured between any two of the sensors.

The minimum particle size that can be measured depends on the wavelength of the available laser light. It may be that future availability of appropriate lasers with wavelength of light close to 0.1 μm results in the minimum size of the particle that can be measured being close to 0.1 μm.

In an alternative embodiment, the apparatus may additionally be used to measure the velocity of particles in the same way that a phase doppler anemometer does. This combined measurement of size and velocity of submicron particles is believed to be new. In such an arrangement, the particle velocity can be measured from the frequency of the detected scattered light signal at each sensor 40.

1. A method of ascertaining the size of small particles, the method including the steps of:
a) intersecting at least two light beams at an intersection volume;
b) sensing at each of a plurality of sensing positions angularly displaced from one another light scattered by a particle substantially in the intersection volume, and producing respective output signals indicative of the sensed light;
c) ascertaining the phase difference between one of the signals and each other of the signals to give a measured indication of the variation of phase difference with angular displacement; and
d) comparing the measured indication with at least one known indication of the variation of phase difference with angle for a known particle size and thereby determining the size of the particle substantially in the intersection volume.

2. A method according to claim 1, wherein the measured indication of the variation of phase difference with angular displacement includes an indication of the angular position of transitions between local maxima and minima of the phase difference.

3. A method according to claim 2, wherein the measured indication includes information identifying the angular position of such transitions.

4. A method according to claim 2, wherein the measured indication includes information identifying the angular position or one or more points on each side of the local maxima and minima.

5. A method according to claim 1, wherein the measured indication of the variation of phase difference with angular displacement includes an indication of the angular position of local maxima and minima of the phase difference.

6. A method according to claim 1, wherein the measured indication includes information indicative of a squarewave of phase difference maxima and minima with angular displacement.

7. (canceled)

8. (canceled)

9. A method according to claim 2, wherein for a plurality of maxima and minima, there is at least one sensing position between each maximum and an adjacent minimum, and between each minimum and an adjacent maximum.

10. A method according to claim 1, wherein step (b) includes generating a respective electrical signal indicative of the light sensed at each sensing position, the light signal being indicative of the frequency of light sensed at the respective sensing position.

11. A method according to claim 1, wherein the sensing positions lie in the same plane as each other, the plane being oblique to an axis through the control volume.

12. A method according to claim 1, wherein step (d) includes comparing the measured indication with the known indication to ascertain that the measured indication substantially matches the known indication, thereby determining that the particle size is substantially the known particle size.

13. (canceled)

14. A method according to claim 1, wherein step (d) includes comparing the measured indication with a plurality of known indications, each for a respective known particle size, to find a pair of known indications between which the measured indication lies, and hence a range of known particle sizes between with the particle size lies.

15. A method according to claim 14, wherein step (d) is followed by the step of interpolating between the two known particle sizes to generate a particle size estimate.

16. A method according to claim 1, wherein the comparison or comparisons of step (d) is or are made with pre-generated information that is recorded for subsequent access.

17. (canceled)

18. (canceled)

19. A method according to claim 1, wherein the particle is one of a stream of particles passing through the intersection volume and the method includes the step of passing a stream of particles through the intersection volume and respectively repeating steps of the method to ascertain the size of each of a plurality of particles of the stream.

20. Apparatus for ascertaining the size of small particles, the apparatus including light emitting means arranged to emit at least two light beams that intersect at an intersection volume, a plurality of sensors each positioned at a respective sensing position angularly displaced from one another and operable to sense light scattered by a particle substantially in the intersection volume produce a respective output signal indicative thereof, and processing means operable to ascertain the phase difference between one of the signals and each other signal to give a measured indication of the variation of phase difference with angular displacement, and operable to compare the measured indication with at least one known indication of the variation of phase difference with angle for a known particle size and thereby determining the size of the particle substantially in the intersection volume.

21. Apparatus according to claim 20, wherein the number and position of the sensing positions are such that transitions between maxima and minima of the phase difference can be detected.

22. (canceled)

23. Apparatus according to claim 21, wherein for a plurality of maxima and minima, there is at least one sensing position between each maximum and an adjacent minimum, and between each minimum and an adjacent maximum.

24. (canceled)

25. Apparatus according to claim 20, wherein at each sensing position there is a sensor operable to generate a respective electrical signal indicative of the light sensed at each sensing position, the light signal being indicative of the frequency of light sensed at the respective sensing position.

26. (canceled)

27. (canceled)

28. (canceled)

29. Computer processing means programmed and operable to carry out at least steps (c) and (d) of a method according to claim 1.

30. (canceled)

31. A record carrier having recorded thereon information indicative of a computer program according to claim 29.
